(19) United States
(12) Patent Application Publication
(10) Pub. No.: US 2003/0187927 A1
(43) Pub. Date: Oct. 2, 2003

(54) Clustering infrastructure system and method

(76) Inventor: David F. Winchell, Manchester, NH (US)

Correspondence Address: RICHARD C. HIMELHOCH, 311 S. WACKER DRIVE, 53RD FLOOR, CHICAGO, IL, 60606-6622, US

(21) Appl. No.: 10/373,631

(22) Filed: Feb. 24, 2003

Related U.S. Application Data
(60) Provisional application No. 60/359,024, filed on Feb. 22, 2002.

(51) Int. Cl. G06F 15/16

(52) U.S. Cl. 709/204

(57) ABSTRACT

A system and method for configuring a cluster of computer nodes to save and restore state in the cluster in the event of node failures. The system and method are implemented through an application programming interface that includes a membership application, a locks application and a dataspace application. The membership application maintains a set of nodes in the cluster. The lock application provides a means for service applications running on the nodes to synchronize access to dataspaces. The dataspaces provide a cluster-wide shared regions in the memory of the cluster members. The API is configured to monitor the cluster members and to coordinate reallocation of a service application if a node running the service application fails.

### RELATED APPLICATIONS

The present application claims the benefit of provisional application No. 60/359,024, filed in the United States Patent Office on Feb. 22, 2002, and incorporates the disclosure in this application herein by reference.

### TECHNICAL FIELD

The present invention is generally related to a system and method for configuring a cluster of computer nodes; and more particularly to an application programming interface (API) for applications which are run on a cluster of computer nodes to save and/or restore state in the cluster in order that they may survive node failures.

### BACKGROUND OF THE INVENTION

Symmetric multiprocessing (SMP) occurs when two or more similar processors, typically connected via a high-bandwidth link, are managed by one operating system. The processors are treated more or less equally, with application programs able to run on any or perhaps all processors in the system, interchangeably, at the operating system's discretion.

The SMP or threads programming model has been used by applications, middleware, and operating systems to solve a wide variety of problems. It deals with concurrent threads of execution on processors, the sharing of memory among these threads, and synchronisation. This model has been used in a process or address space executing on a computer with a number of physical processors which share memory, i.e., an SMP machine. In some cases, these processes may exchange messages or share memory with other processes executing on the same computer node. In other cases, these processes may exchange messages with processes on other nodes connected by a network. The SMP model has proven to be powerful for single node (e.g., single computer) applications.

Computer nodes connected by a network can cooperatively work together to provide service type applications for clients or end-users of the system. However, such systems encounter problems if one or more nodes in the system fail. The present system uses the SMP model as a guide, and expands on this model for solving certain problems associated with networked computer nodes working together.

### SUMMARY OF THE INVENTION

The present invention is directed toward a clustering system and method, that allows a number of machines (e.g., computers) in a network to provide for high availability (HA) and scaling. Specifically, the software layer described herein provides the tools which allow applications to make themselves highly available. Applications running on the computers access the tools through an Application Programming Interface (API). The system and method allows applications in a cluster of computers connected via the network to scale for higher performance and to make themselves tolerant of computer and network failures. There is no reliance on shared storage for cluster operation in the architecture for this API.

The API of the present system is designed for fault tolerance and scaling in a network cluster. A cluster is a collection of nodes (computers) connected by a network. The present system provides an API for applications which run on a cluster. This API is the necessary and sufficient set of operations which are needed for a distributed application with state to make itself withstand arbitrary node failures. In addition, the API can be used to scale an application as nodes are added to a cluster. The API consists of three components: Membership, Locks, and Dataspaces.

As used in this document, the term “the API” is understood to be the same as “the API of this invention which is composed of membership, locks and dataspaces. The term API refers to the syntax and semantics of the programming interface as described herein. The algorithms and computer code which implement the components of the API will be collectively referred to as the “system” or “the infrastructure.”

Membership is the set of nodes in the cluster. Applications may register for membership events. A node joining or leaving the cluster results in membership events being delivered. A membership event consists of a set of members and a view number. The view number is an increasing integer value which is agreed upon by the members for a particular membership transition.

Locks provide a means for applications to synchronize access to dataspaces. The operations on locks are open, close, lock and unlock.

Dataspaces provide cluster-wide shared regions in the memory of the members. To the applications, these appear as cluster-wide shared memory. The operations supported by the API on dataspaces are open, close, read, write, and register for write notifications. Dataspaces are optionally backed by persistent storage.

A typical usage model for the API is as follows:

lock( )

dataspace read( )

perform local memory modifications

dataspace write( )

unlock( )

When the API is used per the usage model, applications can guarantee consistent dataspace contents in the face of the current node crashing at any point of the usage model sequence. Consistent dataspace contents allows for proper recovery by surviving members.

State refers to any data that is important to an application. Especially, state that is needed for recovery in the event of a node failure. Applications with state can use the API to maintain that state in the event of an arbitrary node failure. After the node failure, the state is recoverable by other cluster members. This state is contained in the dataspace API component.

The present API is based on the customary API that is used for programming an SMP (Shared Memory Symmetric Multiprocessor). In effect, the cluster of nodes becomes an SMP machine from the application programmers point of view. The following table shows the analogy between SMP and cluster API entities.

| entity | SMP | Cluster (API) |
|---|---|---|
| Compute element | processor | node |
| Communication | memory | dataspace |
| Synchronization | locks | locks |
| Wait | condition wait | unix select |
| Wakeup | condition signal | dataspace write notification |
| HA | none | membership |

The present system, in effect, provides the illusion of an SMP environment that is extended to a cluster of nodes. The system can be configured to provide notifications of failures of nodes and addition of new nodes (i.e., membership events). These membership events, combined with the SMP-like environment, provide a platform on which HA applications can be easily built. It is noted that the platform itself tolerates failures via internal mechanisms.

The present system is provide with a layered cluster architecture which is fully distributed. Preferably, the system scales to at least 128 nodes and withstands the failure of an arbitrary node. The architecture, from the bottom up, consists of heartbeat, membership, quorum, <locks and dataspaces>. These layers support the API. Above the API are the distributed applications.

The architecture also contains a crash tolerant distributed lock manager (DLM) which uses membership view numbers for lock state rebuilding upon membership transitions. The DLM assigns server nodes with a lock id modulo operation. The architecture also contains a crash tolerant distributed dataspace manager based on a three phase commit algorithm for agreement and using reliable point to point messaging for the metadata messages and unreliable broadcast for the data carrying commit messages. This allows for higher performance than using reliable point to point messages for the commit phase. Applications may register for dataspace write events. This is useful for waking applications which need to make decisions on dataspace contents.

In a first embodiment of the invention, a clustering system comprises an application program for maintaining state between a plurality of nodes in a membership in the event of a failure of at least one of the nodes. The application program contains a crash tolerant distributed lock manager (DLM) which uses membership view numbers for lock state rebuilding upon membership transitions. The application can also contain a crash tolerant distributed dataspace manager based on a three phase commit algorithm for agreement and using reliable point to point messaging for metadata messages and unreliable broadcast for data carrying commit messages. The distributed database manager can provide for atomic updates, and therefore predictable behavior in writer crash scenarios. It also preserves data through arbitrary cluster transformations by using a majority quorum algorithm combined with storing data on every node and waiting for positive acknowledgment of such storing. The system provides for when write operation completes, data written is guaranteed to be available to the next reader, regardless of node failures. Additionally, the system provides that read operations are optimized via the dataspace manager on the local node. The dataspace manager examines its own three phase commit state and based on that state, determines whether the local data is the most recent or that a cluster poll for the latest data is required.

In another embodiment, a system for saving and restoring state in a cluster with arbitrary node failures comprises a plurality of computer nodes connected by a network, and an application programming interface for coordinating a plurality of service applications provided by the computer nodes. The application programming interface includes a membership application for determining which computer nodes are in a cluster, and a lock application for coordinating access to dataspaces maintained by the computer nodes in the cluster. The lock application is configured to rebuild a first service application of the plurality of service applications in response to a change in membership in the cluster identified by the membership application. This can be done for additional service applications as necessary in the same manner. The lock application can be configured to assign an identification value for each lock object in the system. The application programming interface maintains the service applications provided by the computer nodes as highly available.

The membership application identifies all of the computer nodes from the plurality of computer nodes connected by the network that are members of a partition running the application programming interface. In this regard, the membership application produces a membership value for the partition. The membership application is configured to detect a failure of a first computer node in the cluster providing a first service application. A change in membership can be due to a failure of one of the plurality of nodes. The application programming interface is configured to reassign to, or facilitate reassignment of, a second computer node in the cluster to provide the first service application.

The membership application can include a heartbeat layer for transmitting messages at regular intervals to the plurality of computer nodes, an agreement layer to provide agreement for the change in membership, and a quorum layer for accepting registrations from the computer nodes for membership events. The quorum layer is configured to apply a majority policy to the membership events, and record an indication of one of “quorum” and “no quorum” in response to application of the majority policy to the membership events.

The application programming interface further includes a dataspace server application for accepting requests from service applications provided by the computer nodes to read and write to the dataspaces. The dataspaces can be volatile or persistent.

In the system, a first computer node in the cluster can initially provides a first service application. The application programming interface is configured to facilitate utilization of a second computer node in the cluster to provide the first service application in the event of a failure of the first computer node. That is, the application programming interface gives the service applications the tools which can be used so that it (i.e., the service application) can make decisions on which node to run on in the event of a failure.

In yet another embodiment of the invention, an application programming interface for use with a plurality of computer nodes connected by a network wherein the computer nodes are configured to provide service applications for clients comprises a membership layer for detecting members of the plurality of computer nodes forming a partition, and for detecting failures of the members of the plurality of computer nodes forming the partition and, a lock server application for coordinating access to dataspaces maintained by the members of the plurality computer nodes forming the partition.

The membership layer can comprise a heartbeat layer for providing a local opinion of membership of a node. The heartbeat layer can be configured to transmit and receive messages from the plurality of nodes at regular intervals. The messages can be transmitted and received using a user datagram protocol.

The membership layer may further include an agreement layer for obtaining agreement on a change in membership. The agreement layer can be configured to audit membership views. The membership layer can also include a quorum layer for identifying a primary partition of the members.

The lock server application maintains the lock state of a lock object. The lock server application can assign an identification value to the lock object, and maintain a queue of lock requests for each lock object.

In a further embodiment of the invention, a method for providing high availability to a service application run on one or more computers of a plurality of computer nodes connected by a network comprises the steps of providing an application programming interface on a plurality of computer nodes connected by a network, utilizing the application programming interface to initially determine which computer nodes are members of a cluster, utilizing the application programming interface to monitor the computer nodes in the cluster and, utilizing the application programming interface to facilitate reallocation of a service application from a first node to a second node in the cluster in the event of a failure of the first node. Additionally, the method can include utilizing the application programming interface for coordinating access to dataspaces maintained by the members of the cluster.

The method can further include transmitting heartbeat messages at regular intervals to the plurality of computer nodes to monitor changes in members of the cluster. It may also include utilizing the application programming interface for accepting requests from service applications running on members of the clusters to read and write to the dataspaces.

The method can further comprise utilizing the application programming interface for determining whether a quorum of members exist in the cluster. This may include applying a majority policy to determine whether a quorum of members exist in the cluster, and recording an indication of one of “quorum” and “no quorum” in response to determining whether a quorum of members exist in the cluster.

The present invention provides for the strict handling of no-quorum events. The present system also allows applications with general HA models to be built, and is itself HA. That is, the system provides a platform or toolkit upon which can be built HA applications. For example, the HA models may include: active standby, active-active, active-mult standby, mult active-mult standby. Moreover, the system allows applications to be built, which are themselves HA policy engines, supporting their own clients with standard HA policy needs.

The system provides the ability to save and restore state in a cluster with node failures, and the ability to synchronize in a cluster with node failures. The system also utilizes view numbers from membership to synchronize higher levels with respect to membership events handled and not handled (e.g., with shared state (HA policy manager) and without (lock manager)). The system uses a quorum view number and is capable of handling momentary quorum losses in a cluster.

The present system allows an application, built as a state machine, to be instantiated on the nodes in a cluster. In this regard, the state of a state machine running on one node is a function of the state of a state machine running on another, since the state of the state machines can be made visible through the shared state (dataspace) provided by the system. Furthermore, one state machine can be notified that another has changed state by means of the dataspace write notification function.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating the architecture of a system in accordance with aspects of the present invention;

FIG. 2 is a block diagram illustrating a lock client operation in connection with a system in accordance with aspects of the present invention;

FIG. 3 is a block state diagram illustrating a lock server operation in connection with a system in accordance with aspects of the present invention;

FIG. 4 is a block state diagram illustrating an active-standby example a system in accordance with aspects of the present invention;

FIG. 5 is a block diagram illustrating an active-active example a system in accordance with aspects of the present invention;

FIGS. 6-11 are block diagrams illustrating a shared work queue with recovery in accordance with aspects of the present invention;

FIG. 12 is the API function prototype definitions for the membership component for use with a system in accordance with aspects of the present invention;

FIG. 13 is the API function prototype definitions for the lock component for use with a system in accordance with aspects of the present invention; and,

FIGS. 14A-14B are the API function prototype definitions for the dataspaces component for use with a system in accordance with aspects of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present invention is utilized in connection with a set of computers or nodes (sometimes referred to herein as “computer nodes”), connected to one another via a network. The network may be, for example, an ethernet. One or more applications may execute on these computers to provide a service to clients or end-users (sometimes referred to herein as a “service application”). An application that may be executed by the computers can be, for example, a cell phone service.

The invention described here is an application programming interface (API) (i.e., a software layer) which allows the networked computers to work together to provide services that survive failures of certain of these computers. Such a service is then said to be Highly Available (HA).

A collection of the computer nodes connected by the network, which can pass messages to one another and are running the API software described herein, is said to form a partition. The nodes are members of the partition. A membership layer of software within the API detects members in a partition and produces a membership value or set of members for a partition.

The set of possible members for a partition is a set of nodes called the configuration. Having a majority of the configured members in a set is called quorum. A partition with quorum is called the primary partition. For a given configuration, there can be at most one primary partition. Partitions without quorum are called minority partitions. The API is configured so that only the primary partition may run services.

A cluster is a primary partition. If quorum does not exist in any partition, then the cluster does not exist. If the cluster exists, then services can be provided by members of the cluster. If quorum is lost due to a loss of members, the services are no longer provided. Preferably, the usual state is to have a cluster where the number of members exceeds the number required for a majority by several members. Thus the loss of a member or two will not disrupt the cluster.

The API is configured to reallocate resources in a cluster to overcome a fault by one of the members. When a computer which is a member of a cluster fails, the processes that were executing on that computer (which may have been providing a service) are lost. The API directs the surviving members in the cluster to reclaim the state of such services, and ensure that they continue to be provided. For example, if node A of a cluster is providing cell phone call management for 100 calls, then if A fails, another node in the cluster takes over management of the calls and the calls themselves are unaffected by node A's failure.

A shared nothing cluster is one that does not depend on shared storage for operation. These clusters depend only on being able to send and receive messages on a network. The software described herein works in a shared nothing cluster environment. It is possible to have shared storage connected to the shared nothing cluster, and applications can take advantage of the shared storage. However, the API software itself will not use the shared storage.

An HA manager can also be provided with the API, which allows applications which know nothing of the API to run in a highly available fashion. However, such applications may have some loss of capability. The HA manager would use the API to accomplish its tasks.

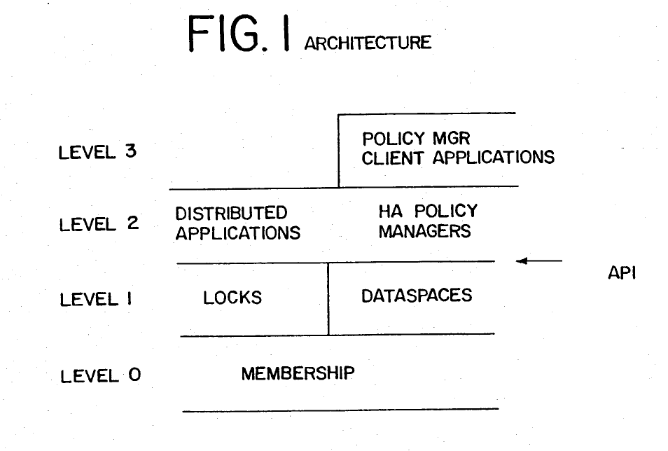

An HA Policy Manager is a distributed application that provides an environment in which its client applications can run in an HA fashion with a minimum of modification required. The HA Policy Manager is shown in FIG. 1 at level 2 and its clients at level 3. While the client applications using the HA Policy Manager give up the complete control and flexibility of a level 3 distributed application, they gain the convenience of minimal modification to make themselves HA.

In one example of an HA Policy Manager, the client application may provide configuration information describing the resources that are required to instantiate a primary instance of the application such as the script to use to start and stop the application, an NFS (Network File System) mount point, and an IP (Internet Protocol) address used by the application to communicate with its clients. Note that whether HA is involved or not, these resources need to be configured for the application.

The actions of the HA Policy Manger involve selecting a node in the cluster for the primary instance of the client application, to mark its own state in a dataspace as to the node selected for that client application, and to configure the resources on that node for the client application, at which time the client application is providing a service for its clients. The HA policy manager, which subscribes to membership events, is aware of the failure of the node on which the example client application was configured. At this point, the HA policy manager, having noted the membership event and having consulted its dataspace and determining that the client application has been lost due to node failure, selects another node in the cluster on which it configures a primary instance of the example client application.

The policy described is known as “primary-cold standby” in that there is not a standby instantiated while the primary client application is active. Another HA policy manager might provide for a “primary-hot standby” where the standby is instantiated and furthermore is being updated with state from the primary instance of the client application through a dataspace, Of course, other Policy Managers could be implemented providing other HA policies.

The API is composed of three primary components: Membership, Locks, and Dataspaces. As discussed in greater detail below, Membership is the set of nodes in the partition. If there is quorum, locks and dataspaces are then available. Locks are objects which can be used for synchronization. Dataspaces are data regions which are shared across nodes of the cluster. Data written to a dataspace can be read from any node in the cluster. Locks are used to synchronize access to dataspaces.

As illustrated in FIG. 1, the system is layered with Membership at the lowest level, level 0, and Locks and Dataspaces at the next level, level 1. The entities at level 1 build (and depend) on the services provided at level 0. The system levels 0 and 1 together provide the API used by higher levels. Level 2 contains distributed applications and Highly Available (HA) policy managers. Level 3 contains the applications managed by the HA policy managers.

The components at levels 1 and 2 and to some degree 3 are distributed in nature. That is, these components run on every node of the cluster and communicate with their peer components to accomplish their task. The components are designed such that they continue to operate when a node in the cluster fails.

The Membership component or layer is the foundation upon which the rest of the architecture is built. The Membership component is responsible for maintaining a list of the current nodes in the membership and sending that list to clients (applications or level 1 components) when changes in membership occur. The Membership component also provides a mechanism whereby clients can register interest in receiving future membership events. The Membership component also determines whether there are enough members in the membership to form a quorum.

Additionally, the Membership component is responsible for detecting the failure of a node in the cluster. This detection and its reporting form the basis for recovery. The Membership component also detects and reports the addition of a new member. Membership events are reported consistently and in the same order on all nodes in the cluster.

The Membership component handles the problem of not being able to tell the difference between a dead node and a slow node by allowing the mistake of calling a slow node dead as long as that (slow) node acknowledges to itself and to the cluster that it has been called out of the membership before it is then allowed to rejoin. Take, for example, a cluster of 10 nodes with identifiers 0-9. Now, let the membership be the set {0, 1, . . . ,9}. Assume node 9 becomes slow. Then as the remaining nodes form the membership {0, 1, . . . ,8}, node 9 must form the membership {9}before it can rejoin cluster.

The Membership component determines quorum with a majority policy. If a majority of the configured nodes are currently members, then there is quorum. The two node configuration is a special case. In that case, a membership of one node is allowed to have quorum if that node can communicate with a network device. In the example above, with 10 nodes configured, the set {0, 1, . . . ,8} has quorum while the set {9} does not.

The quorum policy allows the cluster to provide a primary partition model. With this model, a partition with quorum can provide higher level services, while one without provides only membership services. In the partitions without quorum, higher level services go into a quiescent state, waiting for the next quorum.

The service provided by the Membership component associates a “view number” with each membership transition. The view number for a particular membership transition is the same on each member. Clients on each node see the membership events in the same order, with ascending view numbers.

The service reports a “quorum view number” with each membership event. This is the membership view number when the local node's membership component last made the transition from no quorum to quorum. This value is used in API messages so that applications and infrastructure can synchronize with respect to quorums lost and gained. The need for this can be seen in particular when one considers a momentary loss of quorum.

The Membership component itself is composed of three sub-levels or layers: heartbeat, agreement, and quorum.

The heartbeat layer forms a node local opinion of membership by sending User Datagram Protocol (UDP) messages to, and receiving UDP messages from, heartbeat instances on other nodes. Round trip connectivity is required and ensured with sequence numbers and acknowledgments. Aspects of a heartbeat layer (and agreement layer) that may be utilized are discussed in A Possible Solution to the Impossible Membership Problem, by Massimo Franceschetti and Jehoshua Bruck, California Institute of Technology. Also see A Group Membership Algorithm with a Practical Specification, by Massimo Franceschetti and Jehoshua Bruck, IEEE Transactions on Parallel and Distributed Systems, Vol. 12, No. 11, November 2001; and A Consistent History Link Connectivity Protocol, by Paul LeMahieu and Jehoshua Bruck, California Institute of Technology.

A history agreement protocol is run on the endpoints of each link (i.e., node). Heartbeat messages are sent at a regular interval known as the transmit interval. This is configurable and can be set as low as 10 milliseconds. There is a receive window which is a configurable number of transmit intervals, the default being three. If a messages is acked (i.e., acknowledged) from a node in the window, that node is “timed in,” otherwise it is “timed out”. Tokens are passed as part of the heartbeat messages. The tokens and “timed out” events are passed into the endpoint state machines. The output of the state machines for all connections is the local heartbeat opinion of membership and is queued for the next layer (agreement layer) whenever it changes.

The agreement layer communicates with its peers using a Transmission Control Protocol (TCP) and three phase commit to get agreement on each membership transition. The agreement layer implements an algorithm where the nodes agree on a membership value and a “view number.” Convergence of all local heartbeat opinions is required for a transaction. The node in the local opinion with the lowest node id (i.e., identification number) initiates proposals for new membership views. An audit is added to the known protocols for implement an agreement layer, where the last committed view number is passed in the commit message. Nodes use this to detect when they may have been called out of the membership without their knowledge. Normally, the endpoint state machines have all gone through the correct transitions such that the audit passes. Occasionally, on larger clusters, all of the endpoints may not have cycled as expected and in this case the audit fails. Upon failure, the event is noted and a membership event of {self} queued, favoring the opinion of the cluster at large. Committed membership events are queued for the next layer, the quorum layer.

The quorum layer applies either the network device ping algorithm for a two node cluster or the majority algorithm for larger clusters. For a cluster of size 2N or 2N+1, N+1 nodes are needed for quorum. Besides ensuring only one primary partition, this algorithm has the desirable property of having at least one common node between membership transitions to carry forward the cluster state. The quorum layer adds the quorum value and the quorum view number, as discussed above, to the membership event and sends the event on to the registrants.

The quorum layer accepts registrations for membership events. It does so with one of two priorities specified. The infrastructure (locks and dataspaces) register with high priority and higher layers with low priority. Membership events are delivered to clients in priority order.

The speed with which this system detects a failed node is the heartbeat window size plus a small amount of time compared to that window. At the 10 msec transmit rate and window size of 30 msec the detection time is about 40 msec for a cluster of size 5 nodes. This includes the activities of all three membership layers.

Locks are objects which can provide mutual exclusion. The operations on a lock object are open, lock, unlock, and close. Locks have names, which are passed to the open call. Open returns a lock handle, which in turn, is passed to the lock, unlock, and close calls.

If H is the handle returned by the open call of the lock with name lockA, then when the lock call lock(H) returns in a process, that process is said to own lockA. Other processes in the cluster, who attempt to lock a handle associated with lockA will block until the owner frees lockA with a call to unlock(H). The lock system ensures that there is only one owner at a time for lockA. Typically, a process that wishes to access a shared resource, such as a dataspace, acquires a lock and then accesses the shared resource. This protocol ensures that the shared resource is not corrupted by concurrent access. In a HA cluster, the locks must have correct semantics across failures of nodes or links in the cluster. If process P owns lock A and a node leaves or joins the cluster, then P must still own A, exclusively.

Locks owned by a node that leaves the cluster are freed by the locking service. In addition, when quorum is lost in a partition, lock operations will fail with a NO_QUORUM error code.

There are three processes involved in lock processing. They are the application process, the lock client process, and the lock server process. There is a lock client process and a lock server process on every node in the cluster. The application process uses a library to communicate with the lock client process on a node to acquire and release locks.

The lock client process manages lock requests from application processes on a node. It queues the requests for locks from applications on a node and then makes requests for locks to a server process in the cluster. The lock client process also takes grants for locks from servers and sends them on to application processes. It passes unlock requests from the application on to the server and keeps track of the state of each lock it manages, which is either locked or unlocked. The lock client process reports the state of its locks to servers after membership events.

A lock server process runs on every node of the cluster. The lock server process on node P manages a subset of the total locks in the cluster. The server process maintains a queue of lock requests for each lock it manages. When a lock message is received by the lock server, the server will check its state and if the lock is unlocked it will mark it as locked and send a grant message to the lock client. Otherwise, if the lock is locked, it will queue the lock request. When an unlock message is received by the lock server, it dequeues the first waiter and sends a lock grant to that waiter.

Lock state is maintained in the server process and also in the lock client process on each node. This is done so that locks can be rebuilt after a node running a lock server fails. The lock rebuilding process consists of establishing new lock servers for all locks and having lock client processes report their state to these servers.

Locks have identifiers, id's, which are integer values. In the following discussion, let M be a membership event which consists of [m, v], where m is the set of members and v is the view number. The lock server for a lock with id k is located by a modulus operation. If N is the number of nodes in the membership, m, and if dense_nodes is an array with N elements, which are node id's from m in ascending order, then the node id of the lock server for lock k is given by the function server(k,m), defined as dense_nodes[k%N]. Thus, for any membership set m, a lock client can compute the location of the server for lock k to which requests should be sent. Similarly, for any membership set m, a server process can determine which locks it is responsible for. In the description that follows, and in the figures, the designation server(k,M) will be used instead of server(k,m) to emphasize that we are referring to the server pertaining to membership event M.

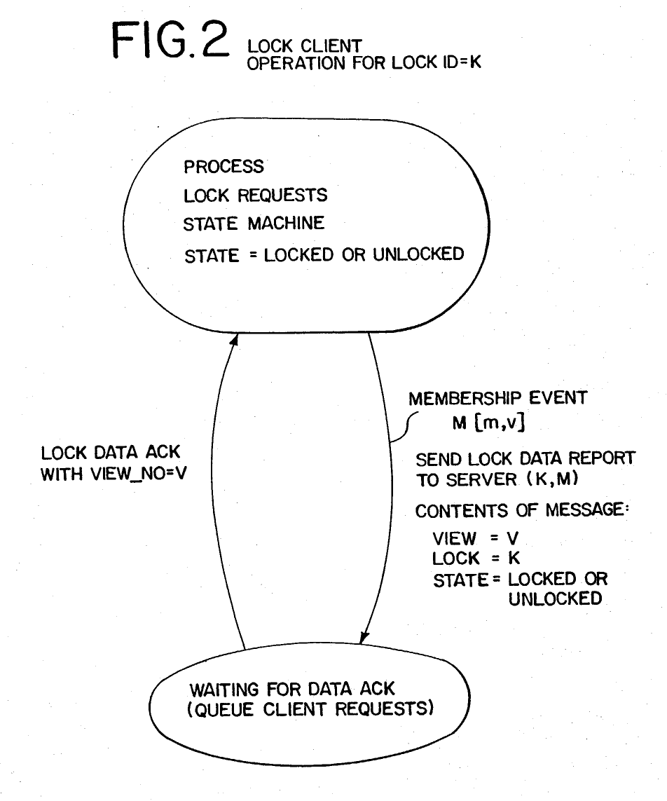

FIG. 2 shows the lock client transitions, for a lock k, that pertain to lock rebuilding. At the top of the diagram is the portion of the lock client state machine which processes lock requests from application processes. The lock client, upon receiving a membership event, M[m,v], sends its state (locked or unlocked) to the server node for k, server(k,M), and marks its state to waiting for ACK. While lock k is in the state waiting for an ACK, it queues any lock requests from application processes. When the data ACK is received from the server, lock k returns to the steady state portion of the state machine.

A lock server process, upon receiving a membership event, determines the locks for which it is responsible. It also accepts the lock status reports from the lock clients and stores them in memory. When the server process on node server(k,M) has received the status reports from all nodes in the membership M for lock k, it checks these reports for any claiming to own the lock. There can be at most one of these. If there is an owner, the lock is marked as locked by the lock client claiming to be owner. If there is no such owner, the lock is marked as unlocked. At this point the lock server sends an acknowledgment to all lock client processes in the cluster for lock k.

The algorithm and method for lock state rebuilding and synchronization is described below:

Let M0 and M1 be successive membership events. As membership event M1 is delivered to lock clients and servers at slightly different times, it is possible that a server S=server(k,M1) receives a lock report R for lock k when, according to the last membership event, MO, that it has seen, it is not responsible for managing the lock. That is, server S gets report R before it has seen event M1.

Synchronisation of the lock client and lock server is accomplished with the membership view number. When a lock client sends a lock data report, R in response to membership event M1, it includes v1 in the report R. The server, server(k,M1), that receives the report R processes that report if the latest membership event, M, it has seen has v=v1 and stores the report R in it memory state for k if v<v1. In the latter case, when server(k,M1) receives event M1 it can then process stored report R.

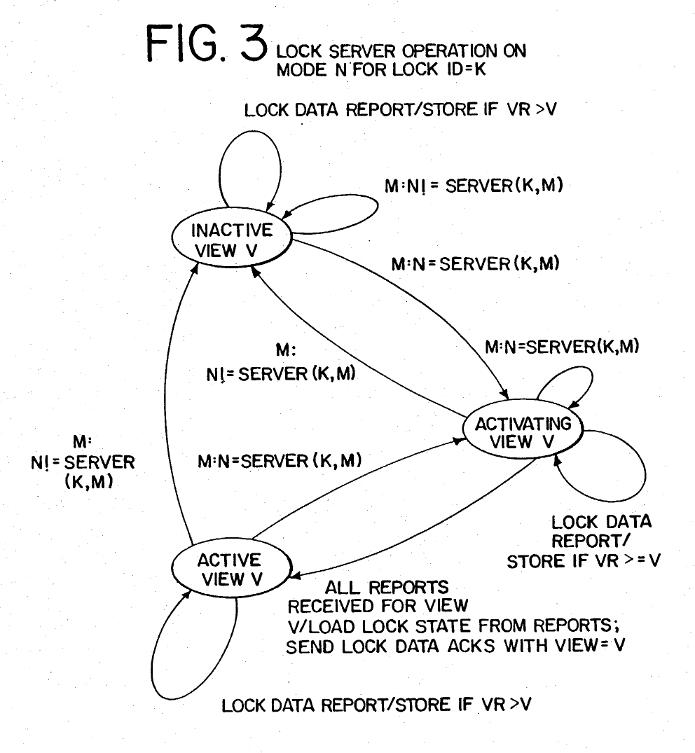

A state diagram of the lock server instance on node N which manages lock k is shown in FIG. 3. In the figure, M is the latest membership event seen by the server. The designation M: N=server(k,M) is read as membership event M is received and node N is the server for k given M. The lock server is in the activating or active state if N=server(k, M), otherwise the lock server is inactive (Note that there will always be a node, though only one node, in the cluster that is in the activating or active state for lock k and membership M.) In the inactive and activating states, the lock server will NACK any lock requests. In the active state the lock server accepts lock requests. The activating state can also be thought of as the state corresponding to lock rebuild.

Whenever the lock server gets a membership event M with view v, it sets the view number in its state for lock k to v. This view number in lock k's state will be referred to simply as v. It also stores M in the lock state and this will be referred to as M. If the event M has the property that N=server(k,M), then the server proceeds to the activating state, otherwise it proceeds to the inactive state.

When the lock server gets a lock report R with view number vr it does the following: If the state of the server is active or inactive then it stores R if vr>v and NACKs it otherwise. If the state of the server is activating then it stores R if vr>=v and NACKs it otherwise.

When in the activating state, after the reception of any report R that was stored, the server checks its state for k to see if a report, R, with vr=v has been received from all nodes in M. If this is the case, the server loads its state from the reports and sends ACKs to all lock clients in M specifying view v in the ACK message. Then it updates its state to active.

Thus, the view number is seen to be the key synchronisation vehicle for the locking service. This method of synchronisation allows for locks to be rebuilt reliably even in a situation where membership is changing rapidly. Furthermore, the rebuilds are performed efficiently as there is a high degree of parallel processing with a minimum of wait states.

Dataspaces are cluster-wide regions into which data can be written or from which data can be read by application processes. Dataspaces have names which are passed to open calls, which in turn return dataspace handles. The handle is passed to the dataspace read and write calls, ds_read and ds_write.

Dataspaces are available in two types: volatile and persistent. Volatile dataspaces retain their data as long as there is a quorum of members. Persistent dataspaces retain their data through periods of time where no quorum exists. However, dataspaces can not be read or written by an application unless the application is running on a node that is a member of a quorum. The type of a dataspace is specified at open time. Note that the open with ds name is a rendevous operation and if the dataspace exists a handle to it is returned and if it does not exist, it is created and a handle returned. When opening a dataspace that exists already, the type requested must match the type of the existing dataspace.

Applications synchronize their access to dataspaces with locks. Dataspaces are updated synchronously. Furthermore, the data is sent to every node in the cluster. When a write call returns, all nodes in the cluster have a copy of the data. This, combined with the majority quorum policy, ensures that the data will survive an arbitrary cluster transformation, as long has quorum is preserved for volatile dataspaces, and in any new quorum for persistent dataspaces.

Dataspace writes are cluster atomic. That is, either the new data is written or the old data is preserved. Application processes can register for dataspace write notifications. Subsequently, they will be notified with a message when the dataspace in question is written.

The dataspaces are preferably implemented with a three phase commit protocol. Again, TCP messaging can be used. The data only rides with the commit messages. The protocol allows nodes in the cluster to realize when they have up-to-date data in the local memory and when they need to seek the latest copy from other members. A dataspace server process runs on each node of the cluster. It accepts requests form application processes to read and write and performs the three phase commit process with its peers for writes. It also manages the read process.

The following are examples of code that may be utilized to implement some of the functions associated with the various components of the API:

Membership:

mb_state

An opaque structure containing a membership view number and a set of members. mb_register_for events, mb_handle_to_fd, select, and mb_read_event

These are used together to retrieve membership events from the membership queue. int mb_get state(mb_state_t *mb_state)

Retrieves the current membership and returns it in mb_state. The membership queue is not affected by this call.

unsigned long

mb_view(mb_state_t *mb_state, int*error)

Retrieves the membership view number from mb_state.

int mb_member(int node, mb_state_t *mb_state)

Tests whether node is a member of the membership set given by mb_state.

int mb_get_node_id(int*error)

Returns the node id of the local node.

int mb_register_for_events(netg_mb_handle**mb_handle)

Register to receive future membership events. Returns a handle.

int mb_handle_to_fd(netg_mb_handle*mb_handle)

Convert the handle to a file descriptor which can be passed to select in order to block waiting for membership events.

int mb_read_event(netg_mb_handle*mb_handle, mb_state_t*mb_state)

When the membership file descriptor is ready, mb_read_event is called to return the event in mb_state.

int mb_unregister_for_events(netg_mb_handle*mb_handle);

Delete the registration.

Locks:

Locks are named cluster objects which provide mutual exclusion. Locks are valid only when there is quorum. If quorum is lost, calls to a lock will return NO_QUORUM. In this event, the application should close the lock, wait for a membership event with quorum, and then open the lock again.

netg_lk_handle*lk_open(char*name, int flags, int*error)

Open a lock by name and return a handle.

int lk_lock(netg_lk_handle*handle)

Lock the lock specified by handle.

int lk_unlock(netg_lk_handle*)

Unlock the lock specified by handle.

int lk_close(netg_lk_handle*)

Close a lock.

Dataspaces:

Dataspaces are named cluster data regions. Volatile dataspaces are kept in memory in the nodes of the cluster. Persistent dataspaces are backed by stable storage on each node. Volatile dataspaces have contents as long as quorum is maintained in the cluster. Dataspaces are valid only when there is quorum. If quorum is lost, calls to dataspaces will return NO_QUORUM. In this event, the application should close the dataspace, wait for a membership event with quorum, and then open the dataspace again. netg_ds_handle*ds_open(char*name, int flags, int* error)

Open a dataspace with name and return a handle. Persistent or volatile is specified in flags.

int ds_close(netg_ds_handle*handle)

Close a dataspace.

int ds_register_for_events(netg_ds_handle*handle)

Register for dataspace write notifications.

int ds_unregister_for_events(netg_ds_handle*handle)

Unregister for write notifications.

int ds_handle_to_fd(netg_ds_handle*handle)

Convert the handle to a file descriptor which can be passed to select in order to block waiting for dataspace write events.

int ds_read_event(netg_ds_handle*handle, ds_event_t*event)

When the dataspace file descriptor is ready, ds_read_event is called to return the event. ds_event_t contains an event_type which is set to DS_WRITE, NO_EVENT, or NO_QUORUM.

A dataspace object is defined as:

typedef struct dataspace {void*data;

size_t db_size; /*number of valid bytes pointed to by data*/

size_t buf_size; /*size of memory buffer pointed to by data*/

unsigned long view_no; /*set to DB_INVALID_VIEW_NO before first read*/}dataspace_t; and is passed to ds_read and ds_write.

int ds_read(netg_ds_handle*handle, dataspace_t*dataspace)

Read the dataspace specified by handle. Return the contents in the memory specified by dataspace. The lock guarding the dataspace should be locked before ds_read is called. int ds_write(netg_ds_handle*, dataspace_t*dataspace)

Write the dataspace specified by handle. Use the memory specified by dataspace as the source. The lock guarding the dataspace should be locked before ds_write is called.

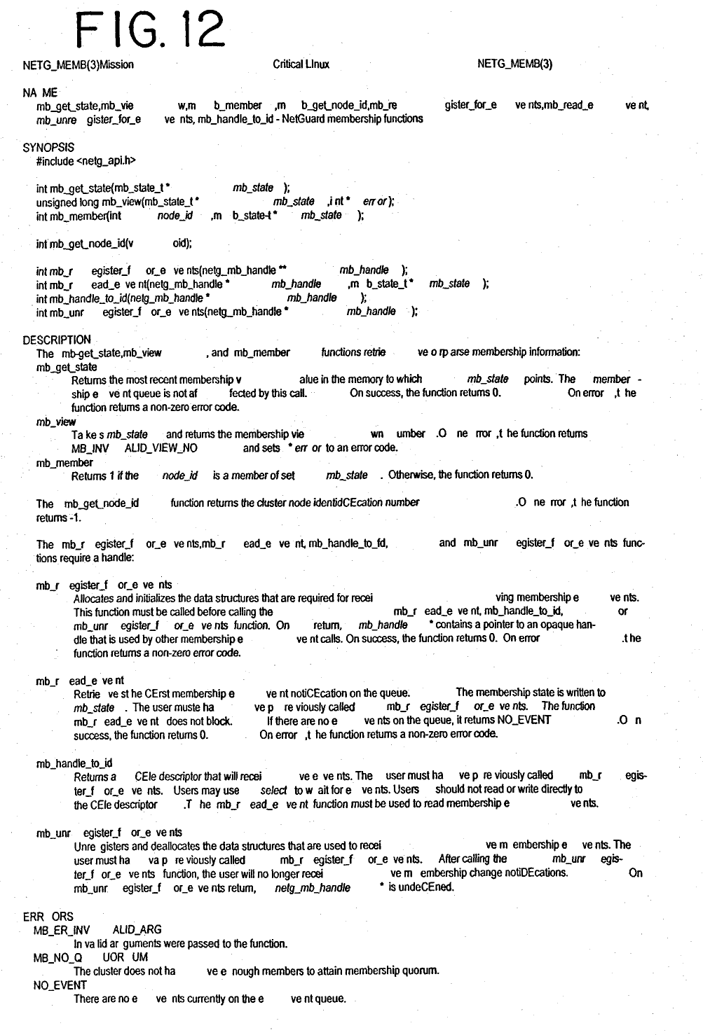

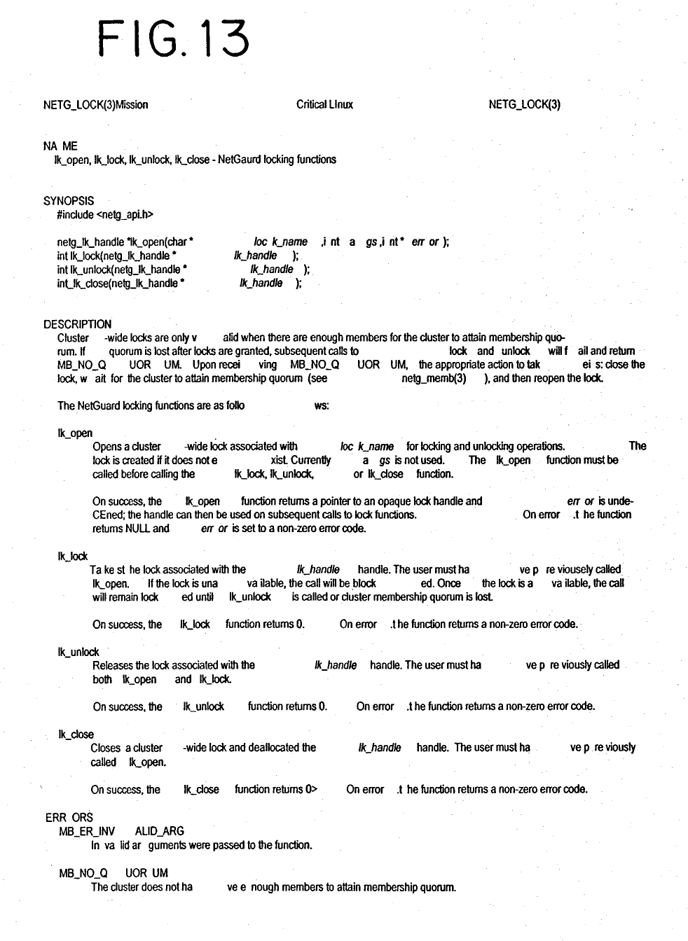

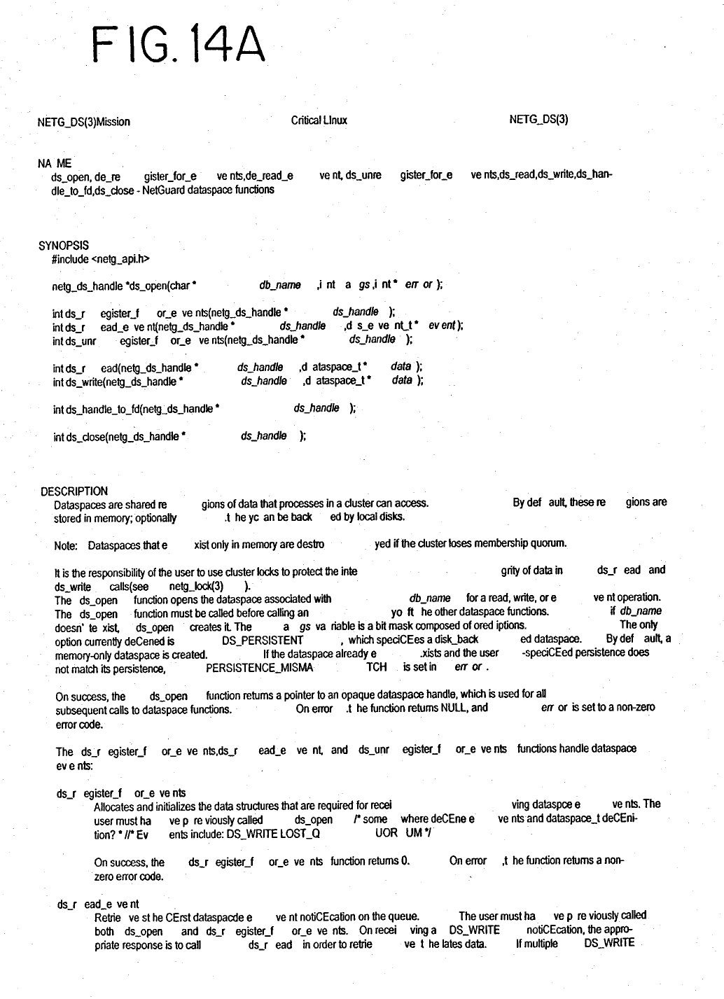

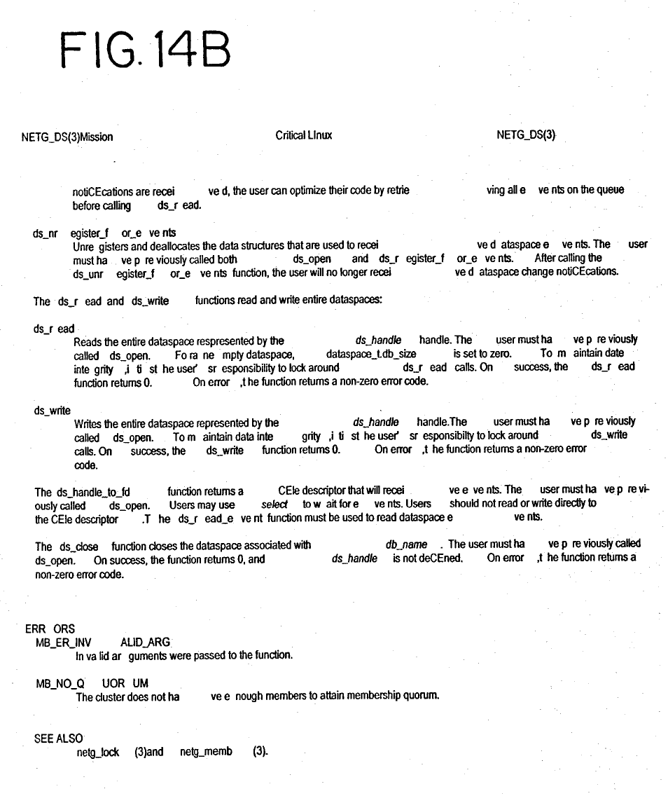

FIGS. 12-14B further illustrate the API function prototype definitions for the Membership, Locks and Dataspaces components that can be implemented for use with the API.

The API described herein can be used to solve general problems, such as HA problems or scaling problems. The API can be used for instances having policies such as active-standby or active-active among others.

An illustration of one use of the present API for an active-standby situation is as follows:

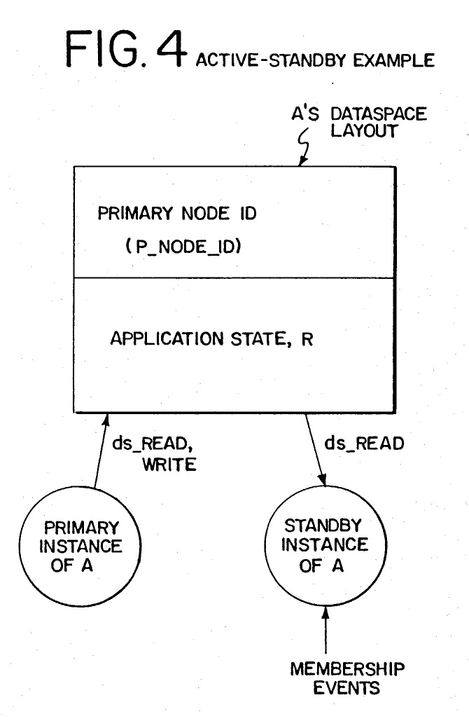

Let application A provide some service S. Certain modifications to this application can be implemented to make it HA. Assume that two instances of A are run at the same time on two nodes of a cluster. One instance, designated the primary, is actually providing the service S. The other instance, designated the standby, is not providing any service currently, but is ready to assume the role of primary, should the primary instance fail (due to the failure of the node on which the primary is executing). Now, let R be the application state which would be needed by the standby in order to take over the active work of the failed primary. For example, in a cell phone application R might describe the state of all the calls being handled. In general, the standby will get a membership event when the primary fails and it will recover state R from a dataspace and become primary. Specifically, the application will use a dataspace in which it stores (writes) state R and the node id of the primary node. Let P_node_id be the name of this latter data item. The dataspace for A, as well as a primary and standby instance of A, is illustrated in FIG. 4.

When the application initializes itself, it sets a variable “Aquorum” to false, registers for membership events (mb_register_for_events) converts the membership handle to a file descriptor (mb_handle_to_fd) and waits in select on that file descriptor for membership events. When the file descriptor becomes ready (a membership event has been received by the operating system) a call to mb_read_event is made in order to retrieve the membership. It then checks the membership event for quorum in this partition. This is indicated by testing whether the local node (mb_get_node_id) is a member with mb_member. If the local node is a member, then there is quorum. If there is not quorum, then the application marks Aquorum to false and returns to wait for more events at the select call. If there is quorum in the membership event and if Aquorum is set to false, then a lock with name “Alock” and a dataspace with name “Adspace” are opened with lk_open and ds_open, and the Aquorum variable is set to true. The ds_open call is made with the flags parameter set to indicate a volatile dataspace. The open calls return handles which are used in subsequent calls. If Aquorum had been found to be true after the membership value was found to have quorum, then there is no need to open the lock and dataspace as they already have been opened and their handles are valid. At this point the application A calls lk_lock to lock its lock and then ds_read to read the contents of the dataspace into local memory. If it gets the return code DS_READ_NO_STATE, then no instance of A is running in the cluster. In this case A allocates a dataspace object and local memory for R and P_node_id, and updates the dataspace object with the address of the local memory and the size of the memory region. It then writes the local node id to P_node_id in the local memory and initializes R in the local memory. Then A calls ds_write passing the handle and dataspace object. Following this, lk_unlock is called. At this point, the application instance has named itself primary and proceeds to perform the work of the primary. Periodically, as work is accomplished and new tasks are taken on, A will update the state R by using the calls lk_lock, ds_write, and lk_unlock.

If the ds_read call above had returned success instead of DS_READ_NO_STATE, then the P_node_id in the data returned would be checked. If P_node_id is a member of the just read membership set then this instance can call lk_unlock, assume the standby role, and go back to select to wait for membership events. If, on the other hand, the P_node_id in the dataspace is found not to be a member of the cluster, then this instance can take over as primary. It would then mark the local node in P_node_id, and then call ds_write and lk_unlock. Now the state R read would form the initial state for this instance of A.

In a further illustration, an example of an active-active instance is described as follows:

This example will be described at a higher level than the active-standby example described above. In this example, it is understood that the API calls are used as in the active-standby example. For example, when the phrase “place Y in or write Y to the dataspace” is used it is understood that the sequence lk_lock, ds_read, modification with Y in local dataspace object, ds_write, and lk_unlock is actually needed to accomplish this.

Active-active refers to an application which is distributed across multiple nodes in a cluster and each instance of the application is performing work for the service and the instances cooperate in some fashion. This is as opposed to the active-standby model where there is only one instance in the active state.

Consider an application, D, which is distributed across N nodes in a cluster. D's function is to perform work W in a scalable way. That is, as nodes are added to the cluster (increasing N) work, W, can be performed in a smaller amount of time. Assume that the total work, W, is broken up into P parts, W1, W2, . . . WP, which can be done in parallel by nodes in a cluster. The completion of every work item Wi is required to complete W. Let R1, R2, . . . RP be the results of each work item. Now add the requirement that any work, Wj, being processed by a node be recovered if that node fails and restarted by another node.

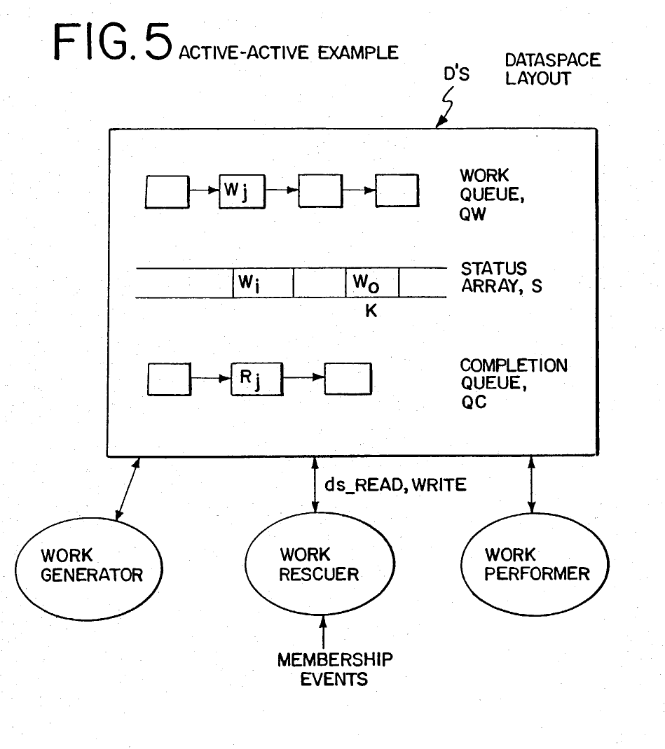

The solution to this problem using the API is described by first considering the layout of a dataspace which will be used by D. In FIG. 5 we have a diagram of the contents of the dataspace. Note, in FIG. 5, there exists a queue, QW, of work items, Wj, to be processed. Also, there is a status array, S, which contains one element for each node in the cluster. The contents of the array element S[j], is the work item, Wk, currently being processed by node j. If a node is not currently processing a job, then its corresponding element in the array S will be set to all zeros. In addition, FIG. 1 shows a completion queue, QC, of results, Rj.

Now let instances of application D be available in one of three roles. They are: work generator; work performer; work rescuer. Each of these roles, can run on a number of nodes in the cluster. There may be a number of each role type instantiated.

The work generator is responsible for examining the state it has and based on that state, generating work items to be performed by D in the cluster. It places the work items on queue QW, the work queue.

The work performer processes work items. It starts by removing an item, Wi, from the work queue, QW, and placing the item in the status array indexed by the local node id: S[local_node_id]=Wi. Then it proceeds to process the work item, Wi. When it finishes with Wi, it places Wi on the completion queue, QC, takes another work item, Wj, from the work queue, writes the item to S, etc.

The work rescuer looks for the condition whereby a node has failed and that node was working on a work item for D. Clearly, the rescuer subscribes to membership events. If node k has failed and S[k] is not all zeros, then the rescuer takes the work item, Wo=S[k], and places it back on the work queue, QW. And, thus, D is both scalable and highly available.

The example can also be used to discuss the issue of atomicity, dataspace writes, and writing node failure. Consider a writing node that crashes in the midst of that ds_write. What are the contents of the dataspace after the crash? Here contents means the data that is retrieved by a subsequent ds_read operation. Atomicity guarantees that either new state being written or the previous state will be the contents of a dataspace.

Applications drafters should keep the crashing writer in mind when using the API. With respect to the above example, the recovery node must queue the recovered work and clear the S element with a single ds_write. In particular, it should not clear the S element, then do a ds_write, then queue the recovered work, and then do a second ds_write. The reason is that the node the recovery instance is on may crash between the two writes and the work item will be lost. The application D, when writing to a dataspace, must move the dataspace from one recoverable state to another.

Distributed applications are at level 2 in the architecture of FIG. 1. Typically, if D is a distributed application, then an instance of D runs on every node in the cluster. The previous examples discussed the implementation of two distributed applications. One was an active-standby application with recoverable state. The other was a scalable application with recovery.

A distributed application implements its own HA policy. It may be active-standby, active-active, N active—M standby, or any policy invented and implemented by the application. The API is a necessary and sufficient set of tools for implementing general HA policy.

A distributed application may be a state machine where the state of a machine on one node is a function of the state of a machine on another. Let F be a distributed application implemented as a Finite State Machine (FSM), or, simply, state machine. A state machine exists in state S1 and, when it receives event E1, invokes a transition routine R=f(S1, E1). That is, the transition routine invoked is a function of the initial state and the event. The transition routine R performs an operation or series of operations. Typically these may include ds_read and ds_write operations. R optionally updates the state of the state machine to a value S2.

Now let F1 by an instance of F executing on node 1 and FN be an instance of F on node N. Then, assume that F uses a dataspace, DSF, and that DSF contains an array, Fstate, that is indexed by node id, and where Fstate[N] is the FSM state of the instance FN. That is, whenever an instance of F changes state, it updates its element in Fstate. In this event, the state and actions of FSM Fi can be a function of the state of FSM Fj as follows:

F subscribes to write events on dataspace DSF. When Fj changes state it updates Fstate[j]. Fi receives the dataspace write event, reads the dataspace, and notes Fj's new state, Fstate[j]. Now Fi can execute a transition routine and proceed to a new state based on the event, dataspace write, its own state Fstate[i], and Fstate[j].

The state has been described as the formal states that define a state machine. The state can be generalized to include whatever state is important to a distributed application for scaling, recovery, or coordination.

The ability to coordinate state machines in a cluster allows for great flexibility and power in solving problems. Furthermore, with the addition of membership events, these problems are solved in a fault tolerant way.

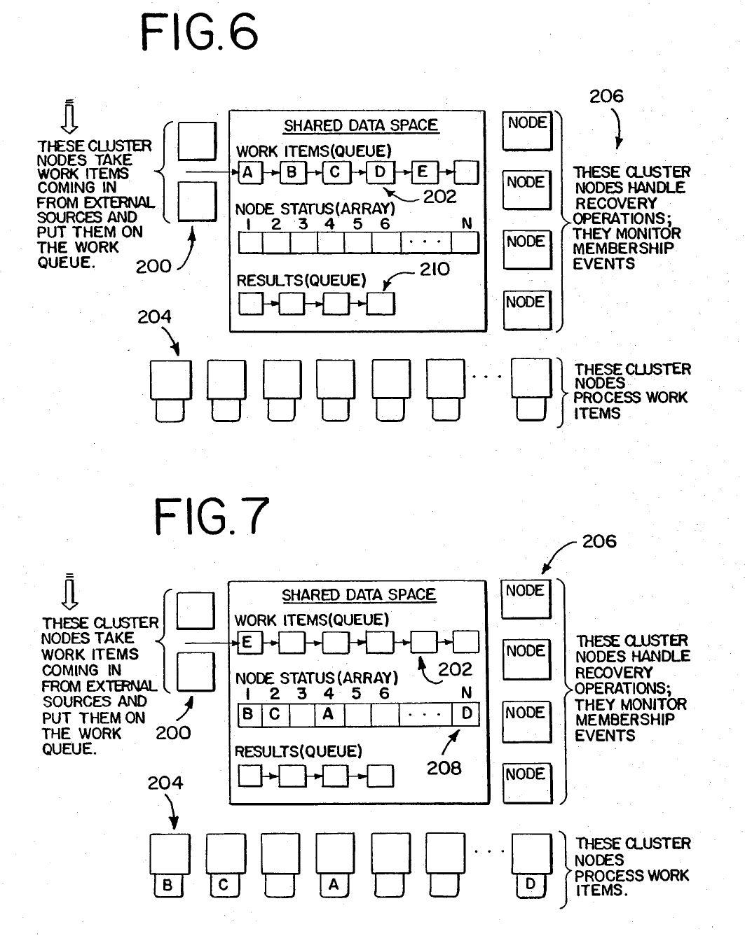

Another example of the system is illustrated in FIGS. 6-11. In this example, the API is configured to designate a first group of cluster nodes 200 to take work items coming in from external sources and put them in a work queue 202. A second group of cluster nodes 204 is designated to process the work items 202. A third group of cluster nodes 206 are designated to handle recovery operations. The third group 206 monitors membership events to facilitate the recovery process.

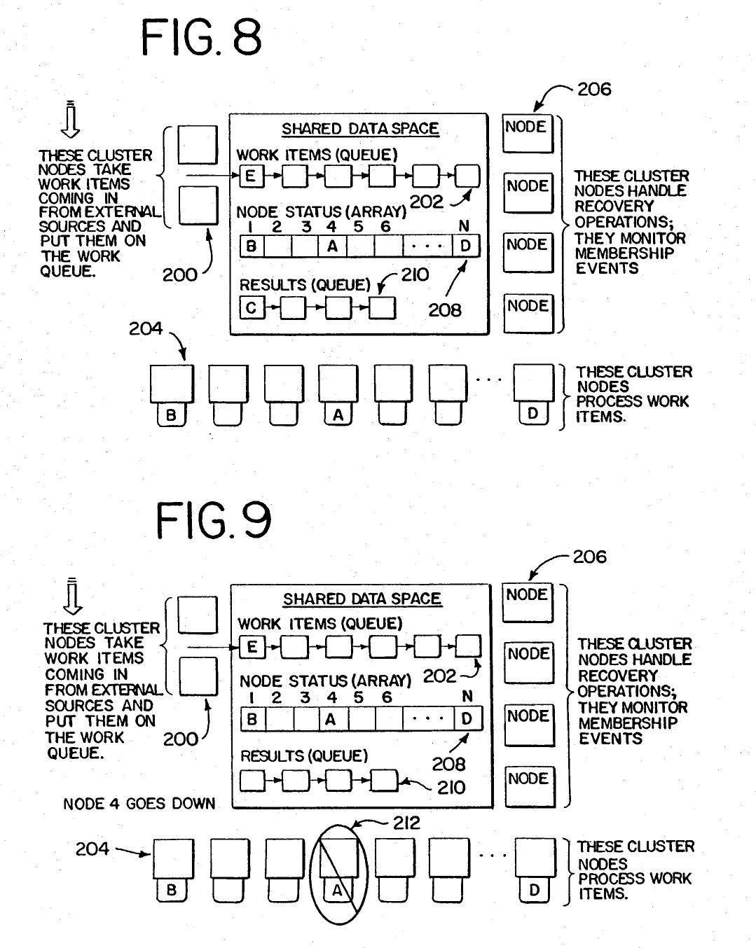

FIG. 6 shows work items A, B, C, D, and E placed in the work queue 202. FIG. 7 shows the first four work items A-D being worked on by nodes in the second group 204. This is also reflected in a node status array 208. When a work item is processed it is then placed in a results queue 210 as illustrated in FIG. 8.

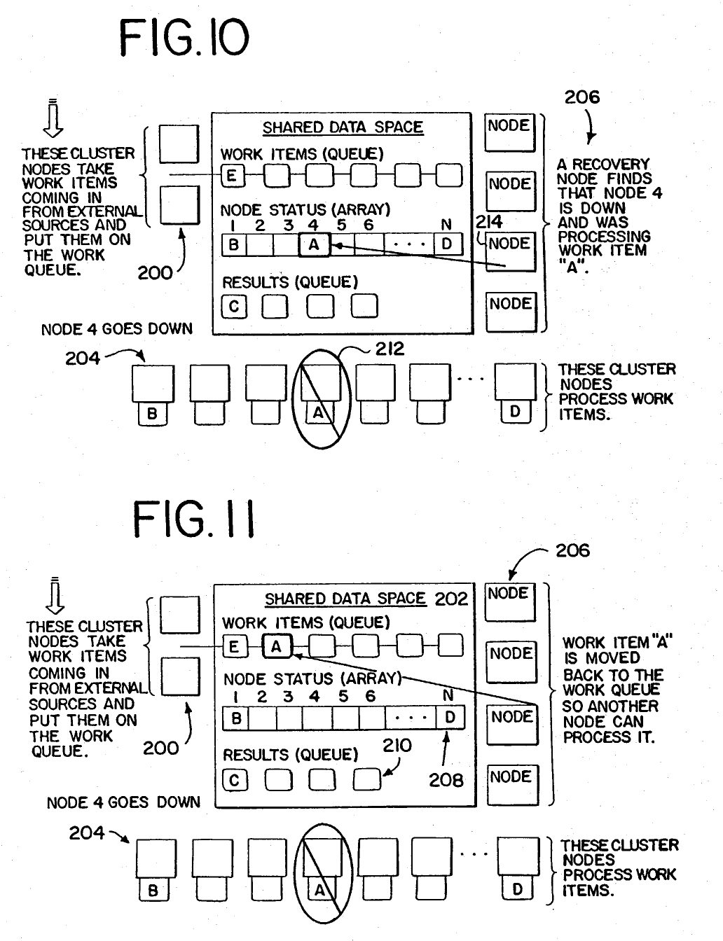

In certain instances, a fault may occur on a node processing a work item. As shown in FIG. 9, the node 212 processing work item A in the second group 204 goes down. This is noted by a recovery node 214 in the third group of cluster nodes 206 as illustrated in FIG. 10. The recovery node 214 moves the work item A back to the work queue 202 so that another node can process it as illustrated in FIG. 11. In this manner, work items are not lost in the event of a failure of a node.

Membership view number synchronization has been described as it pertains to the lock component. There the view number is contained in the messages exchanged between lock client process and lock server process. Additionally, distributed applications may use the view number for synchronisation by writing the view number into the state they keep in dataspaces. Then instances of the distributed application know the basis (which membership event) on which particular state is set in the dataspace. This is important in a distributed system where shared state is visible in the form of dataspaces and where membership events are delivered at different times on the nodes in the cluster.

A membership event with no quorum designated is known as a no-quorum event. No-quorum events may arrive at an application with low frequency, e.g. the network cable is removed from a node and then replaced, or high frequency. Scheduling delays for the heartbeat threads may cause no-quorum events of high frequency. Since locks and dataspaces are lost on the node where quorum is lost, and since as a consequence those locks may be acquired on other nodes, it is important that the infrastructure inform the distributed application when its locks and dataspaces are no longer valid due to quorum loss.

The mechanism for detecting invalid locks or dataspaces involves the lock or dataspace handle returned by the open calls and used in successive calls to API interfaces. As mentioned earlier, the membership event contains a quorum view number (qvn), the view number when the local node last transitioned from no-quorum to quorum. The lock and dataspace open calls query the membership service for the qvn and store the qvn in the object represented by the handle returned. Later, when an operation is invoked, for example ds_write, the library code for ds_write takes the qvn in the handle passed and forwards that in the message to the dataspace server. If the dataspace server has seen a membership event with qvn greater than that mentioned in the message, it sends a NO_QUORUM message back to the client. The client library code then returns from ds_write with a NO_QUORUM error code. At this point the application knows that it has lost quorum and must reset its state and wait for a membership event with quorum, at which point the locks and dataspaces needed are re-opened, which in turn updates the handles with fresh qvn's.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

What I claim:

1. A clustering system comprising an application program for maintaining state between a plurality of nodes in a membership in the event of a failure of at least one of the nodes.

2. The system of claim 1 wherein said application program contains a crash tolerant distributed lock manager (DLM) which uses membership view numbers for lock state rebuilding upon membership transitions.

3. The system of claim 1 wherein said application contains a crash tolerant distributed dataspace manager based on a three phase commit algorithm for agreement and using reliable point to point messaging for metadata messages and unreliable broadcast for data carrying commit messages.

4. A system for saving and restoring state in a cluster with arbitrary node failures comprising:
a plurality of computer nodes connected by a network;
an application programming interface for coordinating a plurality of service applications provided by the computer nodes, the application programming interface including a membership application for determining which computer nodes are in a cluster, and a lock application for coordinating access to dataspaces maintained by the computer nodes in the cluster, the lock application configured to rebuild a first service application of the plurality of service applications in response to a change in membership in the cluster identified by the membership application.

5. The system of claim 4 wherein the membership application identifies all of the computer nodes from the plurality of computer nodes connected by the network that are members of a partition running the application programming interface.

6. The system of claim 5 wherein the membership application produces a membership value for the partition.

7. The system of claim 4 wherein the membership application is configured to detect a failure of a first computer node in the cluster providing a first service application.

8. The system of claim 7 wherein the application programming interface is configured to reassign to a second computer node in the cluster to provide the first service application.

9. The system of claim 4 wherein the membership application includes a heartbeat layer for transmitting messages at regular intervals to the plurality of computer nodes.

10. The system of claim 9 wherein the membership application includes an agreement layer to provide agreement for the change in membership.

11. The system of claim 10 wherein the membership application includes a quorum layer for accepting registrations from the computer nodes for membership events.

12. The system of claim 4 wherein the lock application is configured to assign an identification value for each lock object in the system.

13. The system of claim 4 wherein the dataspaces are volatile.

14. The system of claim 4 wherein the dataspaces are persistent.

15. The system of claim 4 wherein the application programming interface further includes a dataspace server application for accepting requests from service applications provided by the computer nodes to read and write to the dataspaces.

16. The system of claim 4 wherein the application programming interface maintains the service applications provided by the computer nodes as highly available.

17. The system of claim 4 wherein a first computer node in the cluster initially provides a first service application, and the application programming interface is further configured to facilitate utilization of a second computer node in the cluster to provide the first service application in the event of a failure of the first computer node.

18. The system of claim 4 wherein the application programming interface is configured to rebuild a second service application of the plurality of service applications in response to a change in membership in the cluster identified by the membership application.

19. The system of claim 4 wherein the change in membership is due to a failure of one of the plurality of nodes.

20. The system of claim 11 wherein the quorum layer is configured to apply a majority policy to the membership events.

21. The system of claim 20 wherein the quorum layer records an indication of one of “quorum” and “no quorum” in response to application of the majority policy to the membership events.

22. An application programming interface for use with a plurality of computer nodes connected by a network, the computer nodes configured to provide service applications for clients, the application programming interface comprising:
a membership layer for detecting members of the plurality of computer nodes forming a partition, and for detecting failures of the members of the plurality of computer nodes forming the partition; and,
a lock server application for coordinating access to dataspaces maintained by the members of the plurality computer nodes forming the partition.

23. The application programming interface of claim 22 wherein the membership layer comprises:
a heartbeat layer for providing a local opinion of membership of a node, the heartbeat layer configured to transmit and receive messages from the plurality of nodes at regular intervals.

24. The application programming interface of claim 23 wherein the heartbeat layer is configured to transmit and receive messages using a user datagram protocol.

25. The application programming interface of claim 23 wherein the membership layer further comprises:
an agreement layer for obtaining agreement on a change in membership.

26. The application programming interface of claim 25 wherein the agreement layer is further configured to audit membership views.

27. The application programming interface of claim 25 wherein the membership layer further comprises:
a quorum layer for identifying a primary partition of the members.

28. The application programming interface of claim 22 wherein the lock server application maintains the lock state of a lock object.

29. The application programming interface of claim 28 wherein the lock server application assigns an identification value to the lock object.

30. The application programming interface of claim 22 wherein the lock server application maintains a queue of lock requests for each lock object.

31. A method for providing high availability to a service application run on one or more computers of a plurality of computer nodes connected by a network comprising the steps of:
providing an application programming interface on a plurality of computer nodes connected by a network;
utilizing the application programming interface to initially determine which computer nodes are members of a cluster;
utilizing the application programming interface to monitor the computer nodes in the cluster; and,
utilizing the application programming interface to facilitate reallocation of a service application from a first node to a second node in the cluster in the event of a failure of the first node.

32. The method of claim 31 further comprising the step of:
utilizing the application programming interface for coordinating access to dataspaces maintained by the members of the cluster.

33. The method of claim 31 further comprising the step of:
transmitting heartbeat messages at regular intervals to the plurality of computer nodes to monitor changes in members of the cluster.

34. The method of claim 32 further comprising the step of:
utilizing the application programming interface for accepting requests from service applications running on members of the clusters to read and write to the dataspaces.

35. The method of claim 31 further comprising the step of:
utilizing the application programming interface for determining whether a quorum of members exist in the cluster.

36. The method of claim 35 further comprising the step of:
applying a majority policy to determine whether a quorum of members exist in the cluster.

37. The method of claim 36 further comprising the step of:
recording an indication of one of “quorum” and “no quorum” in response to determining whether a quorum of members exist in the cluster.
